(19) United States
(12) Patent Application Publication
(10) Pub. No.: US 2023/0257185 A1
(43) Pub. Date: Aug. 17, 2023

(54) PASSIVE THERMALLY CONTROLLED SHIPPING CONTAINER AND COMPONENTS THEREOF

(71) Applicant: PELICAN BIOTHERMAL, LLC, Plymouth, MN (US)

(72) Inventors: Kai Goellner, Saint Paul, MN (US); Lee Stopher, Cublington (GB)

(21) Appl. No.: 18/040,856

(22) PCT Filed: Oct. 25, 2021
(86) PCT No.: PCT/US2021/056500

§ 371 Date: Feb. 7, 2023

Related U.S. Application Data
(60) Provisional application No. 63/105,488, filed on Oct. 26, 2020.

(51) Int. Cl. B65D 81/38; B65D 25/30; F25D 3/06

(52) U.S. Cl. CPC B65D 81/3883; B65D 25/30; F25D 3/06; F25D 2303/0843

(57) ABSTRACT

A thermally insulated shipping container 100 that includes (i) a banded 140 thermally insulated sleeve 120 with detachable insulated top 150 and bottom 160 trays, (ii) extrudable phase change material panels 180 lining the thermally insulated chamber 129 defined by the banded 140 thermally insulated sleeve 120, and (iii) a payload box 190 with standoff tabs 197 for spacing the payload box 190 from at least two of the sidewalls of the thermally insulated chamber 129.

### BACKGROUND

The shipment of temperature-sensitive goods is difficult when the shipping container itself is not independently temperature-controlled; i.e., does not have an independent power source for maintaining interior temperatures within close parameters.

Goods such as medical supplies, blood, and vaccines are often extremely temperature sensitive and need to be maintained within a given temperature range. Transport of such goods is particularly challenging. Such temperature sensitive goods are shipped to a variety of destinations where the ambient outside temperature varies from extreme cold to extreme heat.

One known solution is to use shipping containers with internal phase change material panels surrounded by exceptionally thick layers of insulation. However, the small ratio of payload chamber volume to container volume results in excessively complicated and expensive storage, handling and transport of the containers.

Another solution is to use shipping containers with internal phase change material panels surrounded by superior thermal insulation panels (i.e., vacuum insulation panels). A number of such shipping containers have been developed over the years including those disclosed and described in U.S Pat. 7,500,593, 7,422,143, 7,257,963, 7,908,870, 7,950,246, 9,751,682, 8,424,335 and 10,766,685 the disclosures of which are hereby incorporated by reference.

While constituting an advance over prior passive thermally controlled insulated shipping containers, a substantial need continues to exist for a passive thermally controlled insulated shipping container providing a superior balance between cost, ratio of payload volume to total volume, strict temperature control throughout the payload chamber, and duration of temperature control.

### SUMMARY OF THE INVENTION

A thermally insulated and passive thermally controlled shipping container and components thereof.

The thermally insulated shipping container includes (i) an outer shell defining a retention volume, (ii) a thermally insulated container lining the retention volume and defining a thermally insulated chamber, (iii) at least one phase change material panel lining the thermally insulated chamber and defining a thermally controlled payload chamber, and (iv) a payload box within the thermally controlled payload chamber. Components of the thermally insulated shipping container are detailed below.

The thermally insulated shipping container can include an insulation sleeve, which includes (i) thermal insulation sidewall panels arranged in abutting fashion to form an insulating sleeve defining an insulated chamber, (ii) two C-shaped sidewall covers surrounding the insulating sleeve, and (iii) at least one compression band around the exterior of the C-shaped sidewall covers compressing the thermal insulation panels together. The insulting sleeve formed by the thermal insulation sidewall panels has an open top, an open bottom and two longitudinally offset pairs of laterally spaced and transversely extending outside corners at each longitudinal end of the insulating sleeve. Each of the C-shaped sidewall covers cover both corners of one of the pair of corners on the insulating sleeve. The C-shaped sidewall covers are undersized so that they do not physically contact one another and thereby accommodate longitudinal compression of the insulating sleeve via the compression band without causing contact between and deformation of the C-shaped sidewall covers. The at least one compression band extends longitudinally and laterally around the exterior of the C-shaped sidewall covers and are operable for compressing the thermal insulation panels together.

The thermally insulated container can include (i) a thermal insulating sidewall sleeve in accordance with the first aspect of the invention and having transversely spaced first and second rims, (ii) a base element including at least a first tray having a first thermal insulation panel retained therein, wherein the base element is configured and arranged for releasable insertion of the first rim of the sidewall sleeve into abutting engagement with the first thermal insulation panel, and (iii) a lid including at least a second tray having a second thermal insulation panel retained therein, wherein the lid is configured and arranged for releasable insertion of the second rim of the sidewall sleeve into abutting engagement with the second thermal insulation panel.

The phase change material panel (PCM panel) can include a hollow panel filled with a phase change material. The hollow panel can be comprised of an extruded hollow body with endcaps sealingly engaging each end of the body. The extruded hollow body has first and second longitudinally spaced open ends, first and second laterally spaced edges and first and second transversely spaced major surfaces. The first and second endcaps sealingly engage the first and second ends of the extruded hollow body respectively.

The payload box can be a one-piece payload box for insertion into the insulated chamber of the thermally insulated shipping container. The payload box has (i) longitudinally spaced first and second sidewalls, (ii) laterally spaced third and fourth sidewalls, (iii) at least one top flap and at least one bottom flap each foldable along a longitudinally extending fold line, (iv) at least two laterally spaced standoff tabs extending longitudinally beyond each of the longitudinal sidewalls of the box from the at least one top flap, and (v) at least two laterally spaced standoff tabs extending longitudinally beyond each of the longitudinally spaced sidewalls of the box from the at least one bottom flap, whereby the standoff tabs are operable for maintaining a gap between the longitudinally spaced sidewalls of the box and longitudinally spaced sidewalls of the thermally insulated shipping container into which the box is inserted.

### BRIEF DESCRIPTION OF THE DRAWINGS

FIG. 1 is an exploded perspective view of an extra small size version of one embodiment of the invention.

FIG. 2 is an exploded perspective view of a small size version of the invention depicted in FIG. 1.

FIG. 3 is an exploded perspective view of a medium size version of the invention depicted in FIG. 1.

FIG. 4 is a perspective view of the fully assembled invention depicted in each of FIGS. 1-3.

FIG. 5 is a perspective view of the fully assembled invention depicted in FIG. 4 with the top flaps of the outer shell open to show the top of the thermally insulated container retained therein.

FIG. 6 is a perspective view of the tray component of the thermally insulated container depicted in each of FIGS. 1-3.

FIG. 7 is a top view of a flat blank which forms the tray component depicted in FIG. 6 when folded.

FIG. 8 is a perspective view of the fully assembled thermally insulated container depicted in each of FIGS. 1-3.

FIG. 9 is an enlarged view of one exterior corner of the fully assembled thermally insulated container depicted in FIG. 8 to facilitate viewing of corner tabs in the C-shaped protective layer component.

FIG. 10 is an exploded perspective view of the thermally insulated container depicted in FIG. 8 with inner liner.

FIG. 11 is a perspective view of the four phase change material panels depicted in each of FIGS. 1-3 in fully assembled arrangement relative to one another.

FIG. 12 is a cross-sectional view of one of the phase change material panels depicted in FIG. 11 taken along line A-A.

FIG. 13 is an enlarged view of a first end of one of the phase change material panels depicted in FIG. 11 with a major surface removed to facilitate viewing of the internal structure of the panel.

FIG. 14 is an enlarged view of a second end of the phase change material panel depicted in FIG. 13 with the same major surface removed to facilitate viewing of the internal structure of the panel.

FIG. 15 is a top view of one of the longitudinally short and laterally short phase change material panels depicted in FIG. 1.

FIG. 16 is a top view of one of the longitudinally short and laterally tall phase change material panels depicted in FIG. 2.

FIG. 17 is a top view of one of the longitudinally long and laterally tall phase change material panels depicted in FIG. 3.

FIG. 18 is a side view of the first end of the phase change material panel depicted in FIG. 15.

FIG. 19 is a side view of the first endcap on the phase change material panel depicted in FIG. 15 showing the internal structure of the first endcap.

FIG. 20 is a side view of the second end of the phase change material panel depicted in FIG. 15 with the second endcap removed to show the internal structure of the body of the panel.

FIG. 21 is a side view of the second endcap on the phase change material panel depicted in FIG. 15 showing the internal structure of the second endcap.

FIG. 22 is a side view of the first end of the phase change material panels depicted in each of FIGS. 16 and 17.

FIG. 23 is a side view of the first endcap on the phase change material panels depicted in each of FIGS. 16 and 17 showing the internal structure of the first endcap.

FIG. 24 is a side view of the second end of the phase change material panels depicted in each of FIGS. 16 and 17 with the second endcap removed to show the internal structure of the body of the panel.

FIG. 25 is a side view of the second endcap on the phase change material panels depicted in each of FIGS. 16 and 17 showing the internal structure of the second endcap.

FIG. 26 is a side view of the second end of the phase change material panel depicted in FIG. 15 with the second endcap removed to show an alternative internal structure of the body of the panel.

FIG. 27 is a side view of the second end of the phase change material panel depicted in FIGS. 16 and 17 with the second endcap removed to show an alternative internal structure of the body of the panels.

FIG. 28 is a perspective view of the payload box depicted in each of FIGS. 1-3.

FIG. 29 is a top view of the invention depicted in each of FIGS. 1-3 fully assembled sans outer shell and lid of the thermally insulated container.

### DETAILED DESCRIPTION OF A PREFERRED EMBODIMENT

### Definitions

As utilized herein, including the claims, the term “tray” means a shallow container with a raised rim.

As utilized herein, including the claims, the phrase “thermal insulating” means a “k” value of less than 0.2 W/mK.

### Nomenclature

Nomenclature Table

| REF No. | DESCRIPTION |
|---|---|
| 100 | Shipping Container |
| 110 | Outer Shell |
| 110 a | Top of Outer Shell |
| 110 b | Bottom of Outer Shell |
| 110 s | Sidewall(s) of Outer Shell |
| 119 | Retention Volume of Outer Shell |
| 120 | Sleeve of Thermal Insulation |
| 120 x | Longitudinal Axis of Sleeve of Thermal Insulation |
| 120 y | Lateral Axis of Sleeve of Thermal Insulation |
| 120 z | Transverse Axis of Sleeve of Thermal Insulation |
| 121 | Open Top of Sleeve of Thermal Insulation |
| 122 | Open Bottom of Sleeve of Thermal Insulation |
| 123 | Sidewall Panels of Sleeve of Thermal Insulation |
| 124 | Outside Corners of Sleeve of Thermal Insulation |
| 125 | First Margin of Sleeve of Thermal Insulation |
| 126 | Second Margin of Sleeve of Thermal Insulation |
| 127 | First Rim of Sleeve of Thermal Insulation |
| 128 | Second Rim of Sleeve of Thermal Insulation |
| 129 | Insulated Chamber |
| 130 | C-shaped Sidewall Cover |
| 131 | Fold Lines in C-shaped Sidewall Cover |
| 132 ₙ | Paired Corner Slits in C-shaped Sidewall Cover |
| 133 | Corner Tabs in C-shaped Sidewall Cover |
| 137 | First Transverse Edge of C-shaped Sidewall Cover |
| 138 | Second Transverse Edge of C-shaped Sidewall Cover |
| 140 | Compression Band |
| 150 | Lid |
| 151 | First Tray |
| 152 | Thermal Insulation Panel in First Tray |
| 160 | Base Element |
| 161 | Second Tray |
| 162 | Thermal Insulation Panel in Second Tray |
| 170 | Insert |
| 180 | Phase Change Material Panel |
| 180 x | Longitudinal Axis of Phase Change Material Panel |
| 180 y | Lateral Axis of Phase Change Material Panel |
| 180 z | Transverse Axis of Phase Change Material Panel |
| 181 | Extruded Hollow Body |
| 181 a | First End of Hollow Body |
| 181 b | Second End of Hollow Body |
| 181 c | First Edge of Hollow Body |
| 181 d | Second Edge of Hollow Body |
| 181 e | First Major Surface of Hollow Body |
| 181 f | Second Major Surface of Hollow Body |
| 182 | External Grip Channels in Major Surfaces of Hollow Body |
| 183 | Center Support Plate in Hollow Body |
| 184 | Support Ribs |
| 185 | First Endcap |
| 185 v | Volume Defined by First Endcap |
| 186 | Second Endcap |
| 186 v | Volume Defined by First Endcap |
| 187 | Beveled End of Second Endcap |
| 188 | Fill Hole |
| 189 | Compartments Defined in Hollow Body |
| 190 | Payload Box |
| 190 x | Longitudinal Axis of Payload Box |
| 190 y | Lateral Axis of Payload Box |
| 190 z | Transverse Axis of Payload Box |
| 190 s | Sidewalls of Payload Box |
| 191 s | First Sidewall of Payload Box |
| 192 s | Second Sidewall of Payload Box |
| 193 s | Third Sidewall of Payload Box |
| 194 s | Fourth Sidewall of Payload Box |
| 195 | Top Flaps of Payload Box |
| 196 | Bottom Flaps |
| 197 | Standoff Tabs |

### Construction

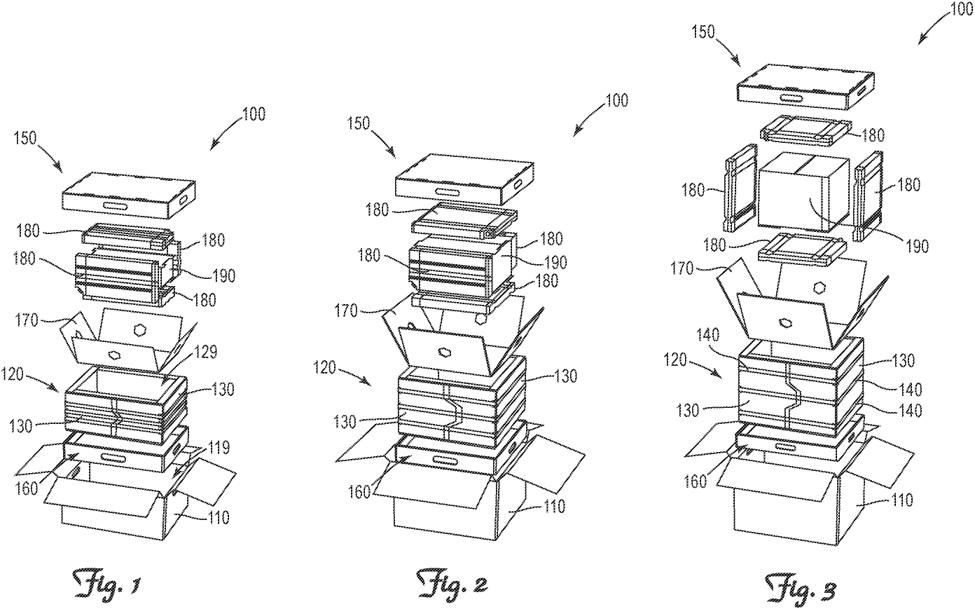

Referring to FIGS. 1-3, the invention is directed to a thermally insulated and passive thermally controlled shipping container 100 and components thereof.

The thermally insulated shipping container 100 includes an outer shell 110, a thermally insulated container (not collectively numbered), at least one phase change material panel 180, and a payload box 190.

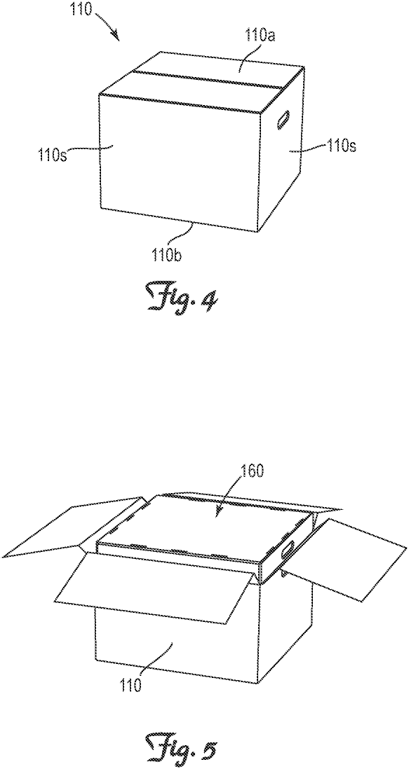

Referring to FIGS. 1-5 and in particular FIGS. 4 and 5, the outer shell 110 is preferably cuboidal and includes a top 110a, a bottom 110b and sidewalls 110s defining a retention volume 119. The outer shell 110 can be comprised of any material having the necessary structural rigidity for retaining the other components of the thermally insulated shipping container 100. Cardboard is a particularly common material for such use.

Referring generally to FIGS. 1-3 and in particular to FIGS. 8-10, the thermally insulated container (not collectively numbered) includes (i) a sleeve of thermal insulation 120, (ii) a lid 150, and (iii) a base element 160.

The sleeve of thermal insulation 120 includes (i) sidewall panels of thermal insulation 123, preferably vacuum insulation panels, (ii) two C-shaped sidewall covers 130, and (iii) at least one compression band 140. The sleeve of thermal insulation 120 lines the retention volume 119 so as to define a thermally insulated chamber 129 within the retention volume 119.

The thermal insulation sidewall panels 123 are arranged in abutting fashion to form an insulating sleeve defining an insulated chamber 129. The insulting sleeve has an open top 121, an open bottom 122 so as to define upper and lower rims 127 and 128 respectively, and two longitudinally 120x offset pairs of laterally 120y spaced and transversely 120z extending outside corners 124 at each longitudinal 120x end of the insulating sleeve.

The two C-shaped sidewall covers 130 protectively surround the insulating sleeve of thermal insulation 120. Each of the C-shaped sidewall covers 130 cover both corners 124 of one of the pair of corners 124 on the insulating sleeve. Each C-shaped sidewall cover 130 may conveniently be comprised of a single-piece sheet with a pair of laterally 120y spaced and transversely 120z extending fold lines 131 configured and arranged to match the configuration and arrangement of the pair of outside corners 124 on the longitudinal 120x end of the insulating sleeve covered by the C-shaped sidewall cover 130.

The C-shaped sidewall covers 130 are preferably undersized in the longitudinal 120x dimension so that they do not physically contact one another and thereby accommodate longitudinal 120x compression of the insulating sleeve via the compression band 140 without causing contact between and deformation of the C-shaped sidewall covers 130. The C-shaped sidewall covers 130 can be comprised of any material having the necessary structural rigidity for spreading out the compressive force of the at least one compression band 140 so as to inhibit compressive crushing of the thermal insulation sidewall panels 123 immediately below the at least one compression band 140. Dimensionally stable cardboard, paperboard and heavy-duty plastic sheeting are generally suitable for this use.

In order to facilitate good thermal abutment of the upper and lower rims 127 and 128 of the insulating sleeve of thermal insulation sidewall panels 123 against panels of thermal insulation 152 and 162 in each of the lid 150 and base element 160 and the respectively, the transverse 120z dimension of the insulating sleeve should be greater than the transverse 120z dimension of each of the C-shaped sidewall covers 130 so that transversely 120z spaced first (upper) and second (lower) margins 125 and 126 of the insulting sleeve extend transversely 120z beyond associated first (upper) and second (lower) transverse edges 137 and 138 of the C-shaped sidewall covers 130.

The at least one compression band 140 extends longitudinally 120x and laterally 120y around the exterior of the C-shaped sidewall covers 130 and are tensioned so as to compress the thermal insulation sidewall panels 123 together. Any of the widely available banding straps are suitable such as steel, pressure sensitive adhesive tape, plastic strapping such as polyethylene, polypropylene, polyester and woven nylon, etc.

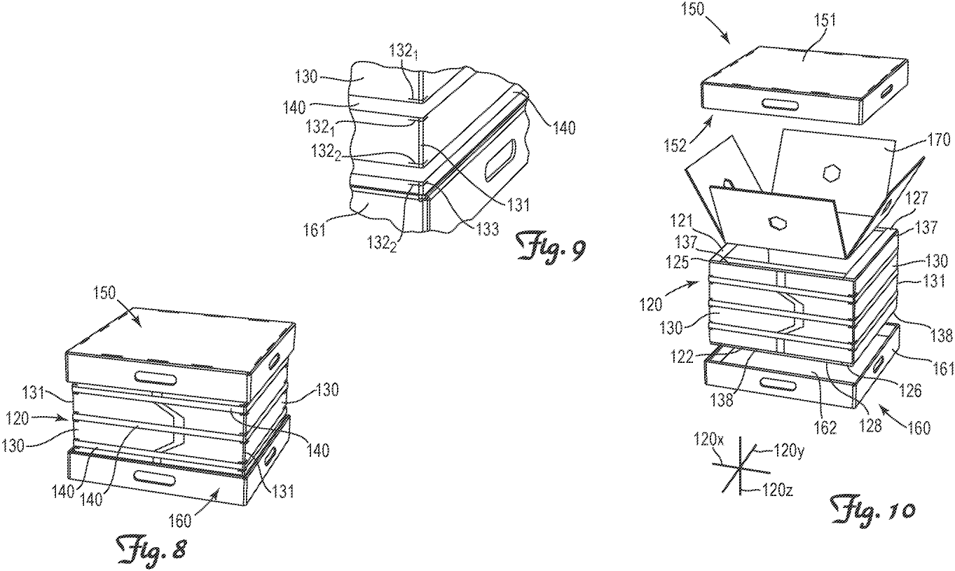

Referring to FIG. 9, paired longitudinally 120x and laterally 120y extending slits 132ₙ can be provided through the C-shaped sidewall covers 130 at each outside corner 124 of the insulating sleeve immediately above and immediately below each compression band 140 to form crushable corner tabs 133 in the C-shaped sidewall covers 130 between each pair of slits 132ₙ. This allows a modest nondestructive inward compression of the corners of the C-shaped sidewall covers 130 immediately underlying the compression band 140 so as to create ridges (not numbered) immediately above and immediately below each compression band 140 to inhibit transverse 120z shifting of the compression band 140 during normal usage of the sleeve of thermal insulation 120.

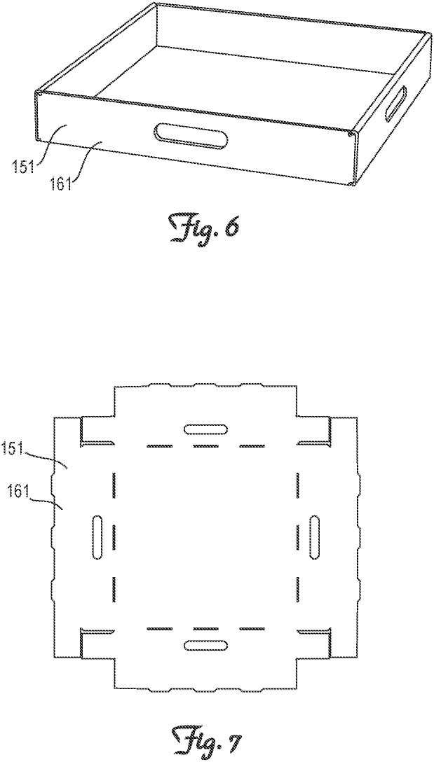

Referring to FIGS. 1-3 and 6-10, the lid 150 is preferably formed as a first tray 151 having a first thermal insulation panel 152 retained therein, wherein the first tray 151 is configured and arranged for releasable friction fit insertion of the first rim 127 on the sleeve of thermal insulation 120 into abutting engagement with the first thermal insulation panel 152.

Again referring to FIGS. 1-3 and 6-10, in similar fashion the base element 160 is preferably formed as a second tray 161 having a second thermal insulation panel 162 retained therein, wherein the second tray 161 is configured and arranged for releasable friction fit insertion of the second rim 128 on the sleeve of thermal insulation 120 into abutting engagement with the second thermal insulation panel 162.

The lid 150 and base element 160 are preferably interchangeable so as to limit inventory requirements and simplify assembly of the thermally insulated shipping container 100.

Referring to FIGS. 1-3 and 10 an insert 170, such as a slit edge box, may be used to line the thermally insulated chamber 129 for protecting the thermal insulation panel 162 in the base element 160 and the sidewall thermal insulation panels 123 forming the sleeve of thermal insulation 120 from damage during insertion, removal and shifting of items placed within the thermally insulated chamber 129. The insert 170 may be constructed from materials also operable for cushioning the payload, absorbing any leakage from the payload, etc.

Referring to FIGS. 1-3, at least one and preferably four phase change material panels 180 line the thermally insulated chamber 129 for defining a thermally controlled payload chamber (unnumbered) for retention of a payload box 190.

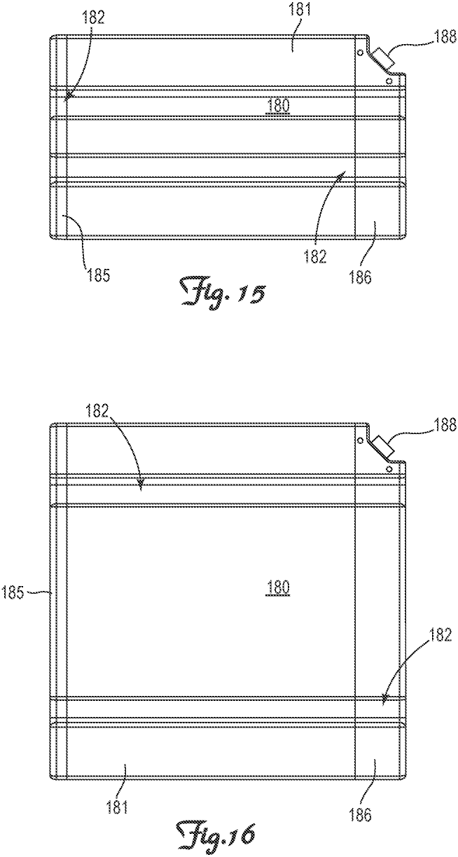

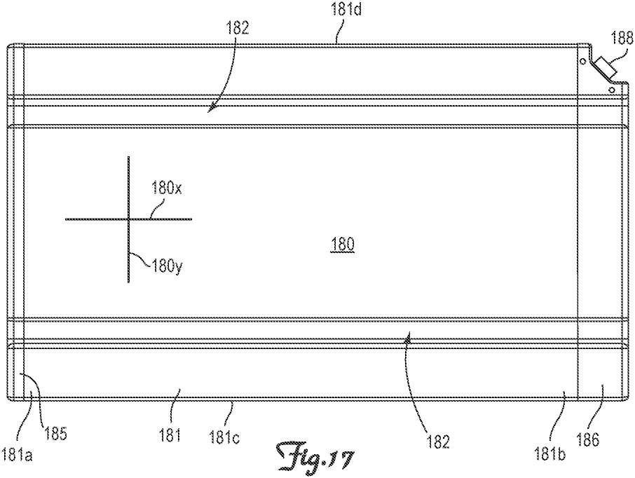

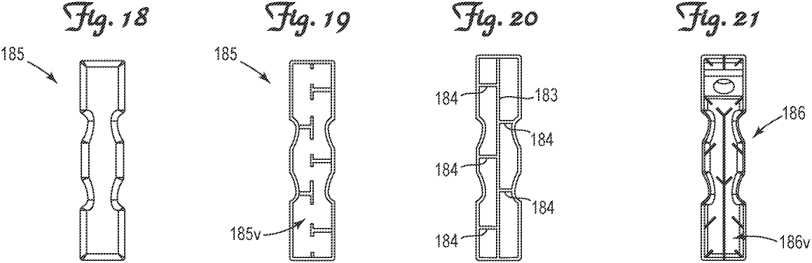

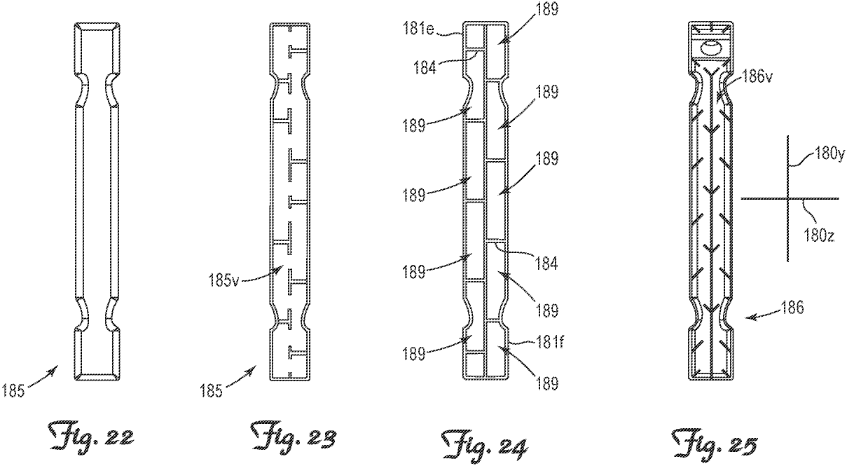

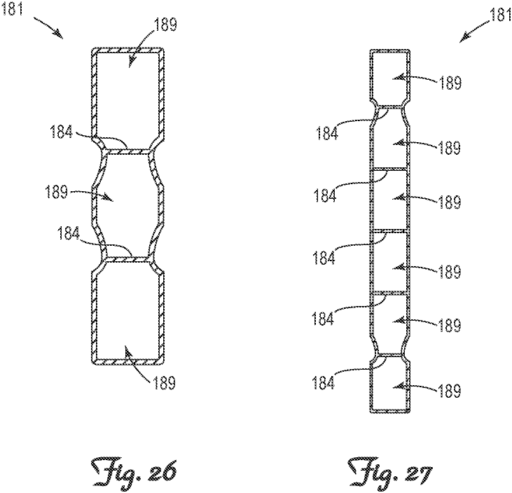

Referring to FIGS. 11-27, each phase change material panel (PCM panel) 180 is a hollow panel defining a longitudinal 180x axis, a lateral 180y axis and a transverse 180z axis, filled with a phase change material (not shown). The PCM panel 180 is preferably constructed from a material possessing limited thermal conductivity so as to prevent formation of a thermal bridge around the phase change material retained within the phase change material panel 180. Suitable materials include plastics which are impermeable to the phase change material to be retained therein.

The hollow panel can be formed from three separate components, an extruded hollow body 181 and a pair of separately formed first and second endcaps 185 and 186. The extruded hollow body 181 has longitudinally 180x spaced first and second ends 181a and 181b sealinging covered by the first and second endcaps 185 and 186 respectively, laterally 180y spaced first and second edges 181c and 181d, and transversely 180z spaced first and second major surfaces 181e and 181f.

The extruded hollow body 181 can be configured and arranges with a longitudinally 180x extending external channel 182 in each major surface 181e and 181f proximate each lateral 180y edge 181c and 181d to accommodate gripping of the phase change material panel 180 from either lateral 180y edge 181c or 181d thereof.

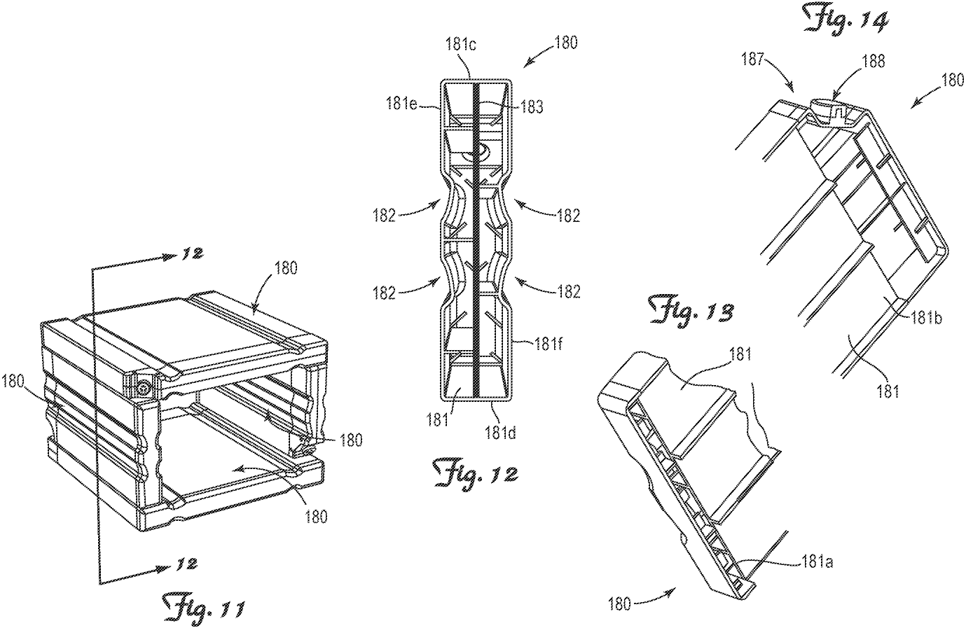

Transverse 180z spacing of the first and second major surfaces 181e and 181f can be maintained and undesired gravity induced separation of the solid and liquid forms of phase change material within the phase change material panel 180 can be limited by incorporating a support structure within the extruded hollow body 181. Referring to FIGS. 12, 20 and 24, an exemplary support structure is a transversely 180z centered longitudinally 180x and laterally 180y extending support plate 183 with a series of transversely 180z extending support ribs 184 extending from the support plate 183 to each of the first and second transversely 180z spaced major surfaces 181e and 181f so as to form a set of separate compartments 189 within the extruded hollow body 181. The separate compartments 189 are preferably in communal fluid communication within the volume 185v and/or 186v of the first and/or second endcaps 185 and 186 respectively.

The support ribs 184 extending to the first major surface 181e are preferably laterally 180y offset from the support ribs 184 extending to the second major surface 181f to prevent formation of a direct linear thermal bridge between the first and second major surfaces 181e and 181f.

Each phase change material panel 180 includes a fill hole 188 for filling the phase change material panel 180 with phase change material. A particularly suitable placement of the fill hole 188 is through a beveled lateral end 187 on one of the endcaps 185 and 186. Such placement of the fill hole 188 facilitates filling of the phase change material panel 180 with phase change material with minimal void volume headspace within the phase change material panel 180 by positioning the phase change material panel 180 at an angle with the fill hole 188 at the peak of the phase change material panel 180 when filling the panel 180.

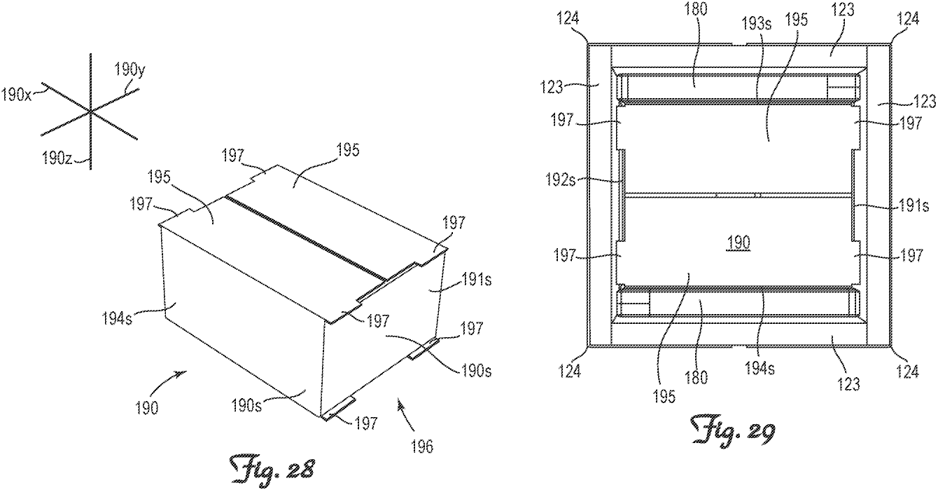

Referring to FIGS. 1-3 and in particular FIGS. 28 and 29, a payload (not shown) may be placed directly into the thermally controlled payload chamber (unnumbered) or placed within a payload box 190 specifically sized, configured and arranged for fitted insertion into the thermally controlled payload chamber (unnumbered).

An exemplary suitable payload box 190 is depicted in FIGS. 28 and 29. This exemplary payload box 190 has (i) longitudinally 190x spaced first and second sidewalls 191s and 192s, (ii) laterally 190y spaced third and fourth sidewalls 193s and 194s, and (iii) transversely 190z spaced top and bottom flaps 195 and 196. The top and bottom flaps 195 and 196 are each foldable along longitudinally extending fold lines (unnumbered). A pair of laterally 190y spaced standoff tabs 197 extend longitudinally 190x from each of the top and bottom flaps 195 and 196 beyond the first and second sidewalls 191s and 192s. The standoff tabs 197 maintain a gap (unnumbered) between the first and second sidewalls 191s and 192s and the longitudinally spaced sidewalls defining the insulated chamber 129 into which the payload box 190 is inserted.

### Use for Thermal Controlled Transport

For simplification purposes only, use of a shipping container 100 in accordance with this invention shall be described based upon the shipping container 100 as depicted in FIGS. 1-3.

Thermally labile goods (not shown) can be loaded into a shipping container 100 for thermally controlled transport by (a) press fitting the sleeve of thermal insulation 120 into the bottom tray 160 to create an insulated chamber 129, (b) inserting the sleeve of thermal insulation 120 fitted into the bottom tray 160 into the retention volume 119 of the outer shell 110, (c) inserting a liner 170 into the insulated chamber 129, (d) placing a thermally conditioned phase change material panel 180 into the bottom of the insulated chamber 129, (e) placing a payload box 190 containing a thermally labile payload (not shown) into the insulated chamber 129 atop the thermally conditioned phase change material panel 180 at the bottom of the insulated chamber 129, (f) sliding a thermally conditioned phase change material panel 180 between each of the third and fourth sidewalls 193s and 194s of the payload box 190 and the laterally spaced sidewalls of the sleeve of thermal insulation 120, and placing another thermally conditioned phase change material panel 180 atop the payload box 190, (g) press fitting the top tray lid 150 onto the sleeve of thermal insulation 120, and (h) closing and fastening the flaps at the top 110a on the outer shell 110.

The recited steps may be performed in a wide variety of sequences. For example, the bottom tray 160 may be inserted into the retention volume 119 of the outer shell 110 prior to fitting of the sleeve of thermal insulation 120 into the bottom tray 160, the thermally conditioned phase change material panels 180 may be inserted into the insulated chamber 129 against the laterally spaced sidewalls of the sleeve of thermal insulation 120 before the payload box 190 is inserted into the insulated chamber 129, etc.

A payload of thermally labile goods (not shown) can be unloaded from the shipping container 100 by (i) opening the top 110a of the outer shell 110 by pivoting the flaps outward so as to provide access to the lid 150 through the open top 110a of the outer shell 110, (ii) removing the top lid 150, (c) removing the phase change material panel 180 resting atop the payload box 190, and (d) removing the payload box 190.

The shipping container 100 can be reused for shipment of another payload of thermally labile goods by replacing the spent phase change material panels 180 with fresh thermally conditioned phase change material panels 180 and repeating steps (d) through (h).

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. A phase change material panel, comprising:
(a) a hollow panel including at least,
(i) an extruded hollow body having first and second longitudinally spaced open ends, first and second laterally spaced edges and first and second transversely spaced major surfaces,
(ii) a first endcap sealingly engaging the first end of the extruded hollow body, and
(iii) a second endcap sealingly engaging the second end of the extruded hollow body wherein the second endcap includes a fill hole therethrough, and
(b) a phase change material retained within the hollow panel.

19. The phase change material panel of claim 18 wherein the second endcap has a beveled end, and the fill hole extends through the beveled end.

20. The phase change material panel of claim 18 further comprising a transversely centered longitudinally and laterally extending support plate with a series of transversely extending support ribs extending from the support plate to each of the first and second transversely spaced major surfaces wherein the support ribs extending to the first major surface are laterally offset from the ribs extending to the second major surface to prevent formation of a direct line linear thermal bridge between the first and second major surfaces.

21. The phase change material panel of claim 20 wherein the support plate and series of support ribs form separate compartments within the hollow body panel which are in communal fluid communication only within at least one end volume defined by each of the first and second endcaps.

22. The phase change material panel of claim 18 wherein the extruded hollow body has a longitudinally extending external channel in each major surface proximate each lateral edge to accommodate gripping of the phase change material panel from a lateral edge thereof.

23. (canceled)

24. (canceled)

25. A thermally insulated shipping container, comprising:
(a) an outer shell defining a retention volume,
(b) a thermally insulated container lining the retention volume and defining a thermally insulated chamber,
(c) at least one phase change material panel in accordance with claim 18 lining the thermally insulated chamber and defining a thermally controlled payload chamber, and
(d) a payload box within the thermally controlled payload chamber.

26. (canceled)

27. (canceled)
